(19) United States
(12) Patent Application Publication
(10) Pub. No.: US 2025/0321461 A1
(43) Pub. Date: Oct. 16, 2025

(54) OPTICAL MODULATOR, LIGHT SOURCE MODULE, OPTICAL ENGINE, XR GLASSES, OPTICAL COMMUNICATION TRANSMISSION DEVICE, OPTICAL COMMUNICATION SYSTEM, AND METHOD FOR CONTROLLING OPTICAL MODULATOR

(71) Applicant: TDK CORPORATION, Tokyo (JP)

(72) Inventors: Shigeru MIEDA, Tokyo (JP); Jiro YOSHINARI, Tokyo (JP)

(73) Assignee: TDK CORPORATION, Tokyo (JP)

(21) Appl. No.: 19/176,988

(22) Filed: Apr. 11, 2025

(30) Foreign Application Priority Data
Apr. 12, 2024 (JP) 2024-064958

(51) Int. Cl. G02F 1/225; G02F 1/21

(52) U.S. Cl. CPC G02F 1/2255; G02F 1/212; G02F 2202/20

(57) ABSTRACT

Provided is an optical modulator in which DC drift is curbed at all times. An optical modulator of the present invention includes a Mach-Zehnder-type lithium niobate ridge optical waveguide, an electrode for applying an electric signal to the ridge optical waveguide, an optical switch configured to switch light output from the ridge optical waveguide, an electric signal source generating the electric signal, and a control circuit controlling the electric signal source and the optical switch. The control circuit controls the electric signal source such that the electric signal alternates between a positive value and a negative value on a time axis, and controls the optical switch so as to extract only light output when the electric signal of a positive value or a negative value is applied.

### CROSS-REFERENCE TO RELATED APPLICATION

Priority is claimed on Japanese Patent Application No. 2024-064958, filed Apr. 12, 2024, the content of which is incorporated herein by reference.

### BACKGROUND OF THE INVENTION

### Field of the Invention

The present invention relates to an optical modulator, a light source module, an optical engine, XR glasses, an optical communication transmission device, an optical communication system, and a method for controlling an optical modulator.

### Description of Related Art

Lithium niobate has a large electro-optic constant, can be used to form optical modulators, optical waveguides, optical switches, optical filters, and the like, and is applied to optical communication devices, visible light devices, and the like.

It is known that a phenomenon referred to as DC drift, in which bias voltage/optical output characteristics shift over time in a bias voltage direction, occurs in a Mach-Zehnder-type optical modulator produced using lithium niobate. For this reason, even if a constant bias voltage is applied to a Mach-Zehnder-type optical modulator, optical outputs change over time due to the DC drift, and therefore there is a problem that it is difficult to obtain constant optical outputs over a long period of time.

Patent Document 1 discloses an invention in which change in operating point voltage caused by DC drift is followed by performing feedback control with respect to a bias voltage on the basis of the average intensity of output light.

This invention provides means for solving limitation on product life caused by a range in which change in operating point voltage can be followed being limited by a withstand voltage or the like of a modulator or an IC. In addition, the means utilize properties that the direction of DC drift has a correlation with the polarity of an applied voltage to realize control over DC drift while keeping the operating point voltage within a prescribed range by changing a bias voltage to a voltage of the opposite polarity when the change exceeds the range of the operating point voltage.

### PATENT DOCUMENTS

[Patent Document 1] Japanese Patent No. 2518138

### SUMMARY OF THE INVENTION

However, the invention disclosed in Patent Document 1 requires operating point voltage detection means for detecting an operating point voltage that is a voltage corresponding to half the maximum optical output. In addition, it is required to perform comparison with inputs of two-system reference voltages for calculating an operating point, which complicates control and mounting.

The present disclosure has been made in consideration of the foregoing problems, and an object thereof is to provide an optical modulator, a light source module, an optical engine, XR glasses, an optical communication transmission device, an optical communication system, and a method for controlling an optical modulator, in which DC drift is curbed at all times.

In order to resolve the foregoing problems, the present disclosure provides the following means.

Aspect 1 of the present disclosure is an optical modulator including a Mach-Zehnder-type lithium niobate ridge optical waveguide, an electrode for applying an electric signal to the ridge optical waveguide, an optical switch configured to switch light output from the ridge optical waveguide, an electric signal source generating the electric signal, and a control circuit controlling the electric signal source and the optical switch. The control circuit controls the electric signal source such that the electric signal alternates between a positive value and a negative value on a time axis, and controls the optical switch so as to extract only light output when the electric signal of a positive value or a negative value is applied.

According to Aspect 2 of the present disclosure, in the optical modulator of Aspect 1, the ridge optical waveguide is formed of a lithium niobate film formed on a substrate, and a C-axis of the lithium niobate is oriented in a direction perpendicular to a main surface of the substrate.

According to Aspect 3 of the present disclosure, in the optical modulator of Aspect 1, the ridge optical waveguide is formed of a bulk of lithium niobate adhered onto a substrate, and a C-axis of the lithium niobate lies in a direction parallel to a main surface of the substrate.

According to Aspect 4 of the present disclosure, in the optical modulator according to any one of Aspects 1 to 3, the electric signal is a square wave voltage signal.

According to Aspect 5 of the present disclosure, in the optical modulator of Aspect 4, a duty ratio of the electric signal is set such that an average voltage becomes 0 V.

According to Aspect 6 of the present disclosure, in the optical modulator according to any one of Aspects 1 to 5, a frequency of the electric signal is 1 MHz or higher.

According to Aspect 7 of the present disclosure, in the optical modulator according to any one of Aspects 1 to 6, the electric signal source includes a modulation signal source and a bias signal source.

Aspect 8 of the present disclosure is a visible light source module including the optical modulator according to any one of Aspects 1 to 7, in which the optical modulator has an optical coupling portion, and the visible light source module includes a plurality of visible laser light sources emitting visible light coupled by the optical coupling portion.

Aspect 9 of the present disclosure is an optical engine including the visible light source module of Aspect 8, and an optical scanning mirror reflecting light emitted from the visible light source module at various angles so as to display an image.

Aspect 10 of the present disclosure is XR glasses including the optical engine of Aspect 9 mounted therein.

Aspect 11 of the present disclosure is an optical communication transmission device including the optical modulator according to any one of Aspects 1 to 7.

Aspect 12 of the present disclosure is an optical communication system including the optical communication transmission device of Aspect 11, and an optical communication reception device having an optical signal reception element for receiving light.

Aspect 13 of the present disclosure is a method for controlling an optical modulator having a lithium niobate ridge optical waveguide and an optical switch provided on an output side of the ridge optical waveguide. The method includes applying an electric signal alternating between a positive value and a negative value on a time axis to the ridge optical waveguide, and controlling the optical switch so as to extract an output signal from the ridge optical waveguide when a voltage having a positive value or a negative value is applied.

According to the optical modulator of the present invention, it is possible to provide an optical modulator in which DC drift is curbed at all times.

### BRIEF DESCRIPTION OF THE DRAWINGS

FIG. 1 is a conceptual diagram of a Mach-Zehnder optical modulator.

FIG. 2 is a view showing a fundamental constitution of an optical modulator.

FIG. 3 is an explanatory view of a case in which a modulation curve of the LN optical modulator moves to a positive side due to DC drift caused by a positive bias voltage.

FIG. 4 is an explanatory view of a method for controlling an optical modulator according to the present disclosure, and the view shows a modulation curve of the optical modulator, a modulation signal voltage applied to a modulation electrode, and an optical output signal output when the modulation signal voltage has a positive value or a negative value.

FIG. 5 is a block diagram of the optical modulator according to the present disclosure.

FIG. 6A is a schematic plan view of the optical modulator according to the present disclosure having three Mach-Zehnder-type optical waveguides 11 as shown in FIG. 2.

FIG. 6B is another example of the optical modulator according to the present disclosure, that is, a schematic plan view of an optical modulator different from that shown in FIG. 6A in having an optical coupler.

FIG. 7A is a conceptual diagram showing a one-stage MMI optical coupler.

FIG. 7B is a conceptual diagram showing a two-stage MMI optical coupler.

FIG. 8 is a schematic cross-sectional view of the optical modulator shown in FIGS. 6A and 6B cut along line A-A′.

FIG. 9 is a schematic plan view of a light source module according to the present disclosure.

FIG. 10 is a schematic cross-sectional view of a part of the light source module shown in FIG. 9 cut along an XZ plane, depicting only a part in the vicinity of a joint portion.

FIG. 11 is an explanatory conceptual diagram of an example of XR glasses of the present disclosure.

FIG. 12 is a conceptual diagram showing a situation in which an image is directly projected onto the retina using laser light emitted from the light source module in the XR glasses shown in FIG. 11.

FIG. 13 is an explanatory conceptual diagram of an optical communication transmission device according to the present disclosure and an optical signal generated by the transmission device.

FIG. 14 is a block diagram of an optical communication system according to the present disclosure.

FIG. 15 is a block diagram showing a modification example of an optical communication system according to another embodiment.

### DETAILED DESCRIPTION OF THE INVENTION

Hereinafter, the present disclosure will be described in detail suitably with reference to the drawings. In the drawings used in the following description, in order to make characteristics easy to understand, characteristic portions may be shown in an enlarged manner for the sake of convenience, and dimensional ratios or the like of each constituent element may differ from actual values thereof. Materials, dimensions, and the like shown in the following description are merely exemplary examples. The present invention is not limited thereto and can be suitably changed and performed within a range in which the effects of the present invention are exhibited.

### [Optical Modulator]

FIG. 1 shows a conceptual diagram of a Mach-Zehnder optical modulator.

An optical modulator according to the present disclosure is a Mach-Zehnder optical modulator (which will hereinafter be referred to as “an optical modulator” or “an LN optical modulator”). The optical modulator includes a Mach-Zehnder-type optical waveguide and an electrode for applying a modulation signal (drive signal) Vₘ.

In the LN optical modulator in an operation state, in addition to a high-frequency signal V_{REF} for modulation, a direct current bias (DC bias) voltage VDC for adjusting a modulation state of an optical output is applied to the electrode. In this case, the bias voltage VDC is a DC component of the modulation signal Vₘ.

The intensity of input light Lᵢₙ supplied from a light source is modulated by the LN optical modulator, and output light Lₒᵤₜ whose intensity has been modulated is output.

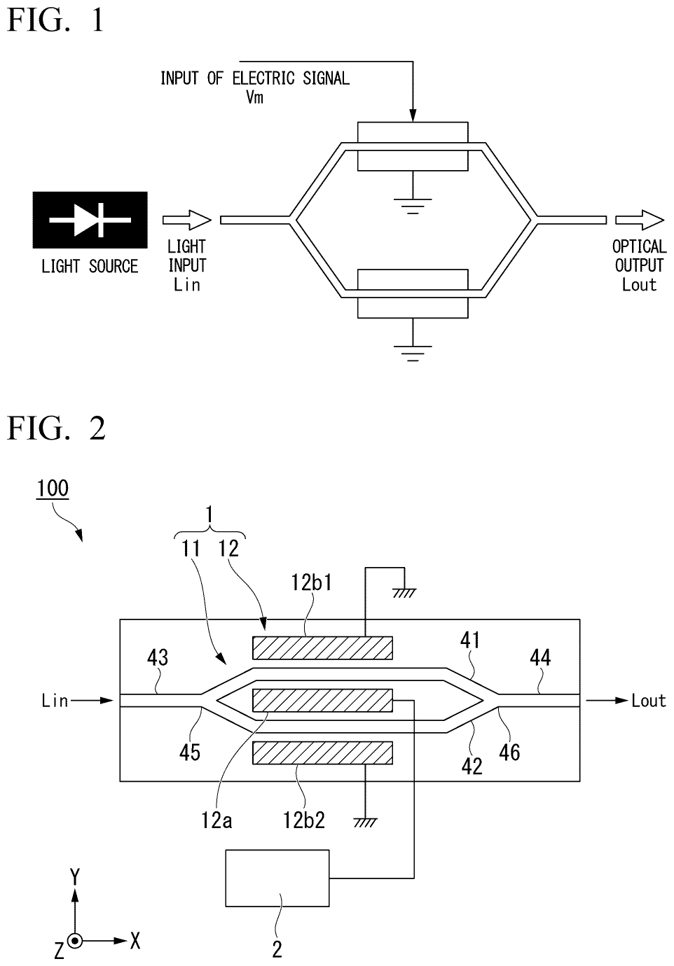

FIG. 2 shows a view of a fundamental constitution of an optical modulator.

An optical modulator 100 shown in FIG. 2 has a Mach-Zehnder-type optical modulation unit 1 including a Mach-Zehnder-type optical waveguide 11 and a modulation electrode (signal electrode) 12 for applying the modulation signal Vₘ to the Mach-Zehnder-type optical waveguide 11, and a signal generation controller 2 supplying the modulation signal Vₘ to the modulation electrode 12.

In FIG. 2, an X direction is a direction orthogonal to a side surface where an input port for inputting input light is disposed, a Y direction is a direction orthogonal to the X direction, and a Z direction is a direction orthogonal to planes formed in the X direction and the Y direction.

In the optical modulator according to the present disclosure, the signal generation controller (an electric signal source and a control circuit) includes a high-frequency signal pulse generation control circuit, a DC bias control circuit, and a switching signal control circuit for controlling an electric signal at a switching timing of an optical switch.

The Mach-Zehnder-type optical modulation unit 1 modulates the intensity of output light in response to the modulation signal Vₘ supplied to the modulation electrode 12. In the Mach-Zehnder-type optical waveguide 11, one input waveguide (optical waveguide) 43 branches into two ridge optical waveguides, such as a first ridge optical waveguide 41 and a second ridge optical waveguide 42, at a Y branch portion 45, and these are again coupled to one output waveguide 44 at a Y branch portion 46. The modulation electrode 12 is constituted of a signal electrode 12a formed between the first ridge optical waveguide 41 and the second ridge optical waveguide 42, and opposing electrodes 12b1 and 12b2 provided in a manner of sandwiching the first ridge optical waveguide 41 and the second ridge optical waveguide 42 therebetween.

In the optical modulator according to the present disclosure, the modulation electrode for the Mach-Zehnder-type optical waveguide can be disposed in a known manner. FIG. 2 is an example in which the modulation electrode is disposed on a lateral side of the Mach-Zehnder-type optical waveguide, but a constitution in which the modulation electrode is disposed above the Mach-Zehnder-type optical waveguide may be adopted.

In the view of the constitution shown in FIG. 2, only the modulation electrode 12 is provided as an electrode for the high-frequency signal V_{REF} and the DC bias voltage VDC, but a constitution in which separate electrodes are provided for the high-frequency signal V_{REF} and the DC bias voltage VDC may be adopted.

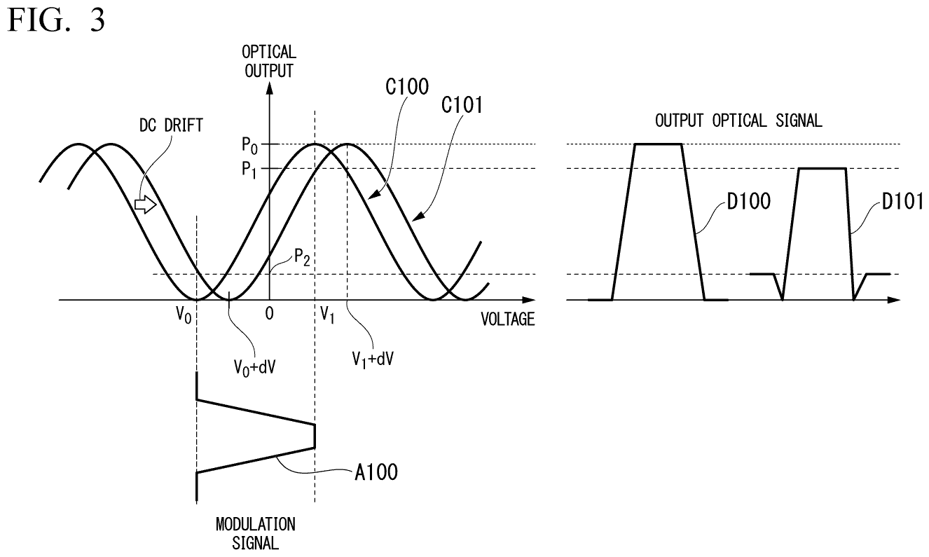

The Mach-Zehnder-type optical modulation unit 1 has a modulation curve (an operating characteristic curve, refer to FIG. 3) unique to the optical modulator, and input light is modulated by the modulation signal Vₘ applied correspondingly to this modulation curve and is output as an output optical signal.

It is known that when the modulation signal Vₘ includes the DC bias voltage V_{D}C (DC component), a phenomenon in which the modulation curve (operating characteristic curve) moves over time (DC drift) in accordance with the polarity of the DC bias voltage VDC occurs.

FIG. 3 is an explanatory view of a case in which the modulation curve of the LN optical modulator has moved to the positive side due to DC drift caused by a positive bias voltage.

The modulation curve of the LN optical modulator is expressed as an optical output (optical intensity) of output light periodically increasing and decreasing with respect to increase in applied voltage.

In FIG. 3, the reference sign C100 indicates a modulation curve when no DC drift has occurred, and the reference sign C101 indicates a modulation curve when DC drift has occurred. In addition, the reference sign D100 indicates an output optical signal when no DC drift has occurred, and the reference sign D101 indicates an output optical signal when DC drift has occurred. A100 indicates a modulation signal (drive voltage).

The example in FIG. 3 shows a case in which voltages at which the minimum value (0) and the maximum value (P₀) of an optical output are obtained correspondingly to an input signal as a binary signal are V₀ and V₁, respectively. If the voltages V₀ and V₁ are fixed when DC drift has occurred, an optical output at the voltages V₀ and V₁ will be P₂ and P₁, respectively, due to the periodicity of the modulation curve. If the volume of drift is dV, in order to maintain the optical output before the DC drift even after the DC drift, it becomes necessary to compensate for the DC drift by setting the voltages V₀ and V₁ to voltages (V₀+dV) and (V₁+dV), respectively.

FIG. 3 shows DC drift caused by a positive bias voltage. However, DC drift caused by a negative bias voltage moves to the negative side.

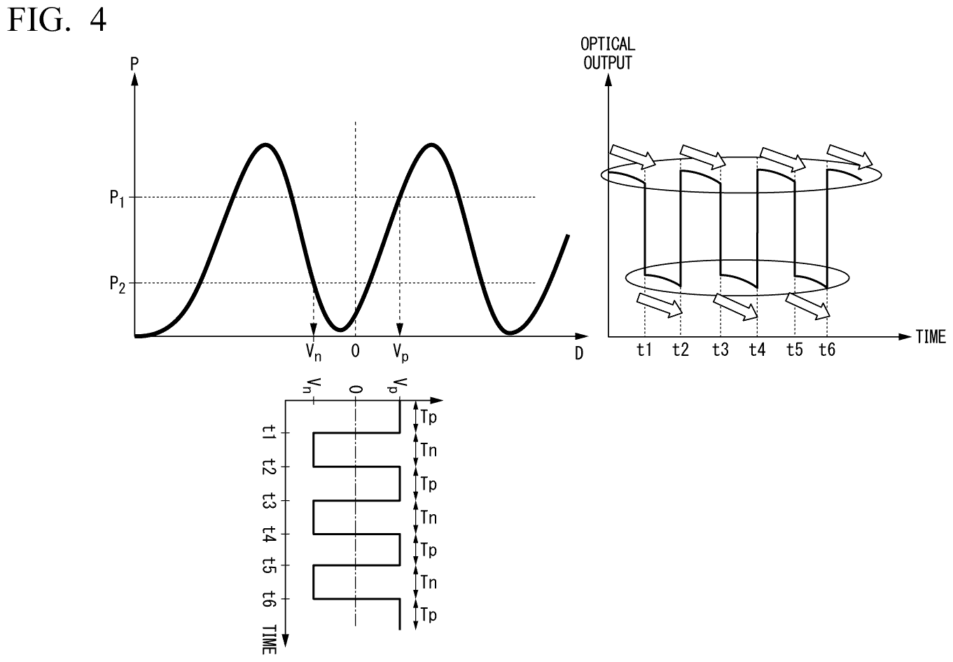

FIG. 4 is an explanatory view of a method for controlling an optical modulator according to the present disclosure, and the view shows a modulation curve of the optical modulator, a modulation signal voltage applied to a modulation electrode, and an optical output signal whose intensity has been modulated.

The modulation signal shown in FIG. 4 is a square wave, but it is not limited to a square wave. The modulation signal is an electric signal having periodicity, and the higher the frequency thereof, the more the ripple in an optical output can be reduced.

As shown in FIG. 4, in the optical modulator according to the present disclosure, modulation signal voltages of opposite polarities are applied alternately. Accordingly, DC drift caused by application of a positive voltage and DC drift caused by application of a negative voltage act such that they cancel out, and change over time in an optical output due to DC drift is curbed.

Due to the constitution in which modulation signal voltages of opposite polarities are applied alternately at all times, DC drift can be offset at all times.

In the optical modulator according to the present disclosure, when optical outputs are P₁ and P₂ when an applied modulation signal has a positive voltage Vp and negative voltage Vn, respectively, there is a period of time during which the voltage is constant due to the properties of a square wave, and therefore, as indicated by the arrows in the graph of an optical output signal in FIG. 4, DC drift progresses in opposite directions when the modulation signal has a positive voltage and when it has a negative voltage. Hence, only the output light when a positive voltage is applied (reference sign A in FIG. 4) or only the output light when a negative voltage is applied (reference sign B in FIG. 4) is extracted by the optical switch. Accordingly, although DC drift progresses during the half period in which the voltage is constant, a voltage of the opposite polarity is applied during the next half period so that the time average of the DC drift becomes zero as a result.

The optical modulator according to the present disclosure has a constitution in which positive and negative voltages are alternately applied at all times in order to obtain a desired optical output.

In the example shown in FIG. 4, the modulation signal alternates between a positive pulse having an amplitude of Vp and a pulse width of Tp and a negative pulse having an amplitude of Vn and a pulse width of Tn periodically and repeatedly.

The duty ratio of the modulation signal can be set such that the average voltage becomes 0 V. In this case, an optical output corresponding to each of Vp and Vn can be kept constant over a long period of time. Here, the term “constant” denotes that the ripple of the optical output is maintained within a range corresponding to ±5% when the maximum optical power is set to 100% based on the voltage-optical output characteristics of the modulator.

The frequency of a periodic electric signal of a modulation signal can be determined from a time constant of DC drift and allowable ripple.

In addition, the frequency of a periodic electric signal of a modulation signal can be set to 1 MHz or higher. In this case, the ripple of an optical output can be further reduced.

The average optical output can be kept constant by extracting only an optical output corresponding to the positive voltage or only an optical output corresponding to the negative voltage.

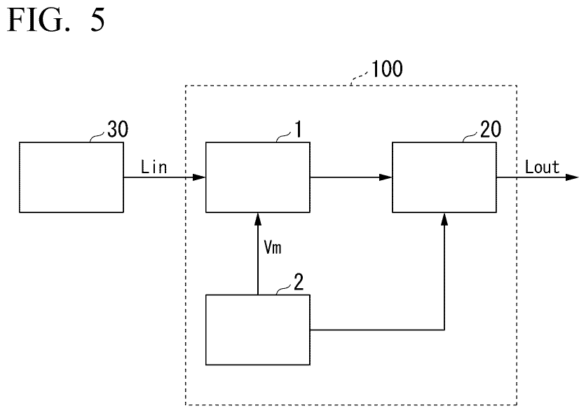

FIG. 5 shows a block diagram of the optical modulator according to the present disclosure.

The intensity of the input light Lᵢₙ supplied from a light source 30 is modulated by the Mach-Zehnder-type optical modulation unit 1 included in the optical modulator 100. The electric signal source is controlled such that the modulation signal alternates between a positive value and a negative value on a time axis by the signal generation controller 2. In addition, the signal generation controller 2 sends a timing signal to an optical switch 20 in synchronization with the timing when a modulation signal having a positive value or a negative value is applied. The optical switch 20 which has received the timing signal extracts only the output light at the time when an electric signal having a positive value or a negative value is applied and outputs the output light Lₒᵤₜ.

Since the optical switch can turn on and off the output light Lₒᵤₜ without converting an optical signal into an electric signal, switching cab be performed while maintaining a high speed.

Various known types (mechanical type, MEMS type, and optical waveguide type) can be used as the optical switch. Particularly, an optical waveguide-type optical switch is preferable because it is realized by lightwave circuit technology for creating an optical waveguide and it is easy to be miniaturized and integrated.

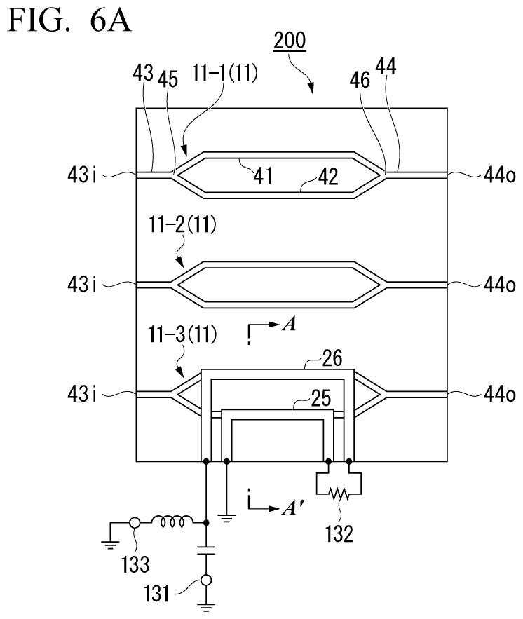

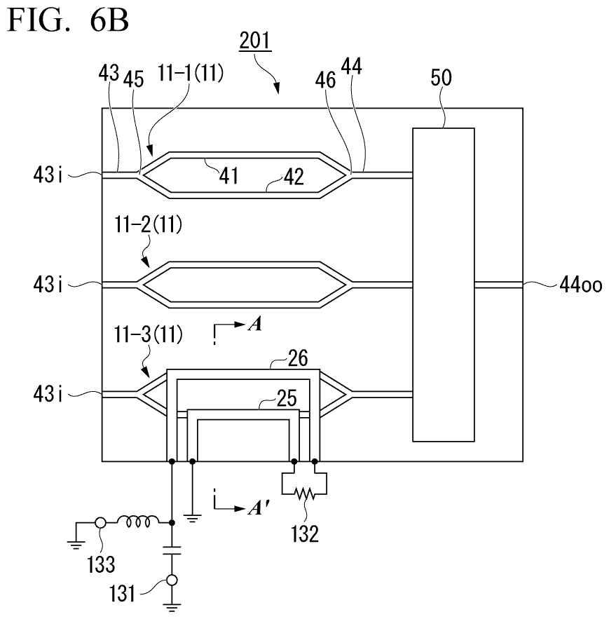

FIG. 6A is a schematic plan view of the optical modulator according to the present disclosure having three Mach-Zehnder-type optical waveguides 11 as shown in FIG. 2. Illustration of the optical switch is omitted (the same applies to the following diagrams).

An optical modulator 200 shown in FIG. 6A includes three Mach-Zehnder-type optical waveguides 11-1, 11-2, and 11-3, but three is an example, and it can include two, four, or more optical waveguides.

In the optical modulator 200 shown in FIG. 6A, light input from each of input ports 43i of the three Mach-Zehnder-type optical waveguides 11-1, 11-2, and 11-3 is output from an output port 44o of each of the optical waveguides.

The constitution of the electrode and the circuit diagram shown in FIG. 6A are examples. FIG. 6A shows a case in which a DC bias voltage is superimposed on a high-frequency signal in electrodes 25 and 26.

The electrodes 25 and 26 are electrodes applying a modulation voltage to each of the Mach-Zehnder-type optical waveguides 11-1, 11-2, and 11-3. The electrode 25 is an example of a first electrode, and the electrode 26 is an example of a second electrode. A power source 131 is a part of the high-frequency signal pulse generation control circuit applying a modulation voltage to each of the Mach-Zehnder-type optical waveguides 11. A power source 133 is a part of the DC bias control circuit applying a DC bias voltage to each of the Mach-Zehnder-type optical waveguides 11. For the sake of simplicity of the diagram, the electrodes 25 and 26 are shown in only the part of the Mach-Zehnder-type optical waveguide 11-3.

FIG. 6B is another example of the optical modulator according to the present disclosure, that is, a schematic plan view of an optical modulator different from that shown in FIG. 6A in having an optical coupler.

In an optical modulator 201 shown in FIG. 6B, light input from each of the input ports 43i of the three Mach-Zehnder-type optical waveguides 11-1, 11-2, and 11-3 is coupled by an optical coupling portion 50 and is output from one output port 44oo.

A multimode interference (MMI) optical coupler can be used as the optical coupling portion 50.

The MMI optical coupler has characteristics in which a plurality of modes from a 0th-order mode to a higher-order mode interfere with each other and an image is formed (converged) at a certain particular position (at a predetermined distance from an input end) in the MMI optical coupler. It is known that a distance or a period (beat length) L between adjacent convergence points almost follows Expression (1). Expression (1) represents the beat length L between two lower-order modes, such as the 0th-order mode and a 1st-order mode.

$$[ Math 1 ]$$

$${L}_{π} = \frac{π}{{β}_{0} - {β}_{1}} ≅ \frac{4 {nW}_{e}^{2}}{3 λ} \qquad ( 1 )$$

In Expression (1), We indicates an effective width of the MMI optical coupler, n indicates an effective refractive index of the MMI optical coupler, and, indicates a wavelength of input light. β₀ and β₁ indicate propagation constants of the 0th-order mode and the 1st-order mode, respectively. From Expression (1), it is ascertained that the beat length depends on the width and the wavelength of the MMI optical coupler.

When an electromagnetic field distribution encounters a phase change of 27 in all propagation modes generated inside the MMI optical coupler, an optical intensity distribution coincides with an incident light intensity distribution. An optical propagation distance required to realize this coincidence (convergence) state is referred to as a self-projection distance, and convergence is repeated with a period of Lπ after a certain propagation distance of 3Lπ/4.

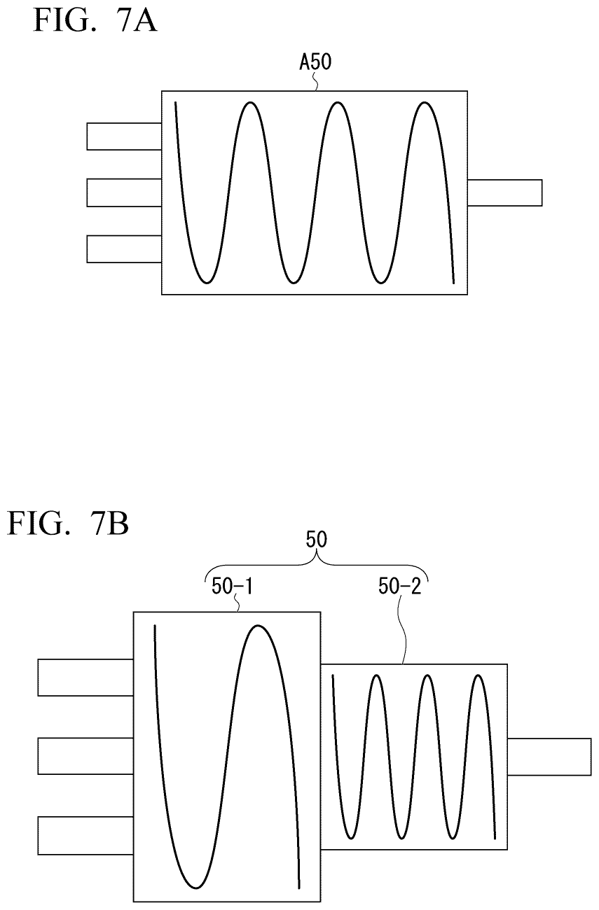

FIG. 7A conceptually shows a one-stage MMI optical coupler, and FIG. 7B conceptually shows a two-stage MMI optical coupler.

FIG. 7A shows an MMI optical coupler including one MMI optical coupling portion A50, and FIG. 7B shows that including a two-stage MMI optical coupling portion 50 in which a first MMI optical coupling portion 50-1 having a wide width and a second MMI optical coupling portion 50-2 having a narrow width are connected from the input side.

The waves inside the optical coupling portion conceptually show the period of interference (beat length). From the foregoing Expression (1), the period of interference (beat length) is proportional to the square of the width of the optical coupling portion for each wavelength. Therefore, the waves inside the optical coupling portion shown in FIGS. 7A and 7B conceptually show that the beat length (beat period) increases as the width of the optical coupling portion becomes wider and the beat length (beat period) decreases as the width becomes narrower for each wavelength. As the beat length of each wavelength is shortened, the distance that is an integer multiple (least common multiple) of the beat length is shortened so that the length of the MMI optical coupling portion can be shortened.

In the two-stage MMI optical coupler shown in FIG. 7B, by making the width (y direction) of the latter-stage MMI optical coupling portion of the two-stage MMI optical coupling portions narrower than the width (y direction) of the front-stage MMI optical coupling portion, the beat length inside the latter-stage MMI coupling portion is shortened so that miniaturization of the optical coupler in its entirety can be achieved.

For example, when being mounted in an eyeglasses-type terminal, it is preferable that the width of the front-stage MMI optical coupling portion be 1.9 μm or longer from the viewpoint of current processing technology or the like.

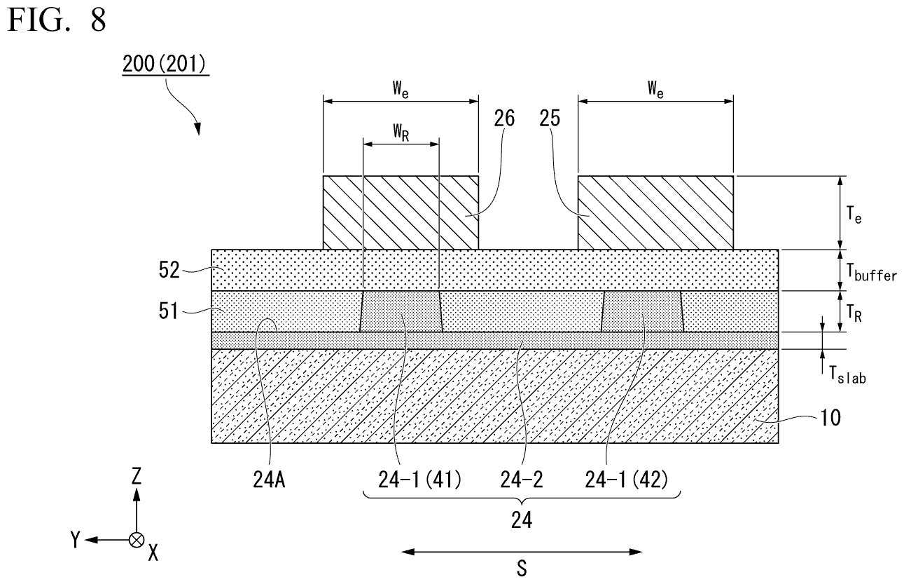

FIG. 8 is a schematic cross-sectional view of the optical modulator shown in FIG. 6A cut along line A-A′. The same applies to the schematic cross-sectional view of the optical modulator shown in FIG. 6B cut along line A-A′.

The optical modulator 200 (201) shown in FIG. 8 has a substrate 10 made of a material different from lithium niobate, and a lithium niobate film 24 formed on a main surface of the substrate 10.

As shown in FIG. 8, the lithium niobate film 24 is constituted of ridge optical waveguides 24-1 (corresponding to the first ridge optical waveguide 41 and the second ridge optical waveguide 42) protruding from a first surface 24A, and a slab layer 24-2 that is a part other than the ridges. However, a constitution having only the ridge optical waveguide with no slab layer may be adopted.

When the optical modulator 200 (201) shown in FIG. 8 is used in an eyeglasses-type image display device, the thickness (T_{slab}) of the slab layer 24-2 of the lithium niobate film 24 is preferably 0.1 to 0.3 μm, and the thicknesses (T_{R}) of the ridge optical waveguides 24-1 of the lithium niobate film 24 are preferably 0.5 to 1.0 μm.

This is because light does not propagate if the thicknesses (T_{R}) of the ridge optical waveguides 24-1 are small, and propagating light is in a multimode if it is large.

When the optical modulator 200 (201) shown in FIG. 8 is used in an eyeglasses-type image display device, the distance (S) between the ridge optical waveguides 24-1 is preferably 2 to 12 μm.

This is because the efficiency of the electric field applied to the ridge optical waveguides 24-1 can be enhanced by reducing S.

In addition, the width (W_{R}) of the upper surface of each ridge optical waveguide 24-1 is preferably 0.3 to 1.2 μm.

This is because light does not propagate if the waveguide width is small, and propagating light is in a multimode if it is large.

Examples of the substrate 10 can include a sapphire substrate, a Si substrate, and a thermally oxidized silicon substrate.

Since an optical coupling functional layer 20 is constituted of a lithium niobate (LiNbO₃) film, there are no particular limitations as long as the refractive index is lower than that of the lithium niobate film. However, a sapphire single crystal substrate or a silicon single crystal substrate is preferable as a substrate on which a single crystal lithium niobate film can be formed as an epitaxial film. The crystal orientation of a single crystal substrate is not particularly limited. However, for example, since a C-axis oriented lithium niobate film has three-fold symmetry, it is desirable that the single crystal substrate in the base also has the same symmetry. A c-plane substrate is preferable in the case of a sapphire single crystal substrate, and a (111) plane substrate is preferable in the case of a silicon single crystal substrate.

For example, the lithium niobate film is a C-axis oriented lithium niobate film. For example, the lithium niobate film is an epitaxial film epitaxially grown on the substrate 10. The epitaxial film is a single crystal film whose crystal orientation is aligned by the base substrate. The epitaxial film is a film having a single crystal orientation in the z direction and a direction within an xy plane, and the crystals are aligned and oriented in all directions of the x axis, the y axis, and the z axis. Whether a film formed on the substrate 10 is an epitaxial film can be verified, for example, by checking the peak intensities and the poles at the orientation positions in 2θ-θ X-ray diffraction.

Specifically, when measurement is performed using 2θ-θ X-ray diffraction, all the peak intensities other than a target surface are 10% or lower and preferably 5% or lower than the maximum peak intensity of the target surface. For example, when the lithium niobate film is a C-axis oriented epitaxial film, the peak intensities thereof other than a (00L) plane are 10% or lower and preferably 5% or lower than the maximum peak intensity of the (00L) plane. Here, (00L) is a general indication for equivalent planes, such as (001) and (002).

In addition, in conditions for checking the peak intensity at the foregoing orientation position, the orientation in one direction is indicated only. Thus, even if the foregoing conditions are met, when the crystal orientation is not aligned within the plane, the X-ray intensity will not increase at a particular angle position, and no pole will be observed. For example, when the lithium niobate film is a lithium niobate film, since LiNbO₃ has a trigonal crystal structure, there are three poles of LiNbO₃ (014) in a single crystal. In the case of lithium niobate, it is known that it grows epitaxially in a so-called twin crystal state in which crystals rotated 180° about the C-axis are symmetrically coupled. In this case, since two poles are in a symmetrically coupled state for each of the three poles, there are six poles. In addition, when a lithium niobate film is formed on a silicon single crystal substrate with a (100) plane, the substrate has four-fold symmetry so that 4×3=12 poles are observed. In the present disclosure, a lithium niobate film epitaxially grown in a twin crystal state is also included in the epitaxial film.

The composition of lithium niobate is LiₓNbA_{y}O_{z}. A is an element other than Li, Nb, and O. The subscript x is 0.5 to 1.2 and preferably 0.9 to 1.05. The subscript y is 0 to 0.5. The subscript z is 1.5 to 4.0 and preferably 2.5 to 3.5. Examples of the element A include K, Na, Rb, Cs, Be, Mg, Ca, Sr, Ba, Ti, Zr, Hf, V, Cr, Mo, W, Fe, Co, Ni, Zn, Sc, and Ce, and it may be a combination of two or more kinds of these elements.

Moreover, the lithium niobate film may be a lithium niobate single crystal thin film bonded onto a substrate.

### (Protective Film 51)

As shown in FIG. 2, a protective film 51 is disposed between the slab layer 24-2 of the lithium niobate film 24 and a buffer layer 52. The protective film 51 is made of a dielectric material having a smaller refractive index than the lithium niobate film 24. For example, silicon oxide (SiO₂), aluminum oxide (Al₂O₃), lanthanum oxide (La₂O₃), a compound of these oxides, or the like can be used as the material of the protective film 51. Examples of the compound of the foregoing oxides include LaAlSiInO. It is preferable to use silicon oxide (SiO₂) among the foregoing materials as the material of the protective film 51.

### (Buffer Layer 52)

The buffer layer 52 is formed on the lithium niobate film 24 and the protective film 51 and prevents visible light propagating through the lithium niobate film 24 from being absorbed by the electrode layer.

The buffer layer 52 is made of a dielectric material having a smaller refractive index than the lithium niobate film 24.

The dielectric material constituting the buffer layer 52 preferably has a dielectric constant of 7 or larger. This is because electric field efficiency VπL can be reduced.

Specific examples of the material of the buffer layer 52 include aluminum oxide (Al₂O₃, dielectric constant 7) and LaAlSiInO (dielectric constant 11).

The material of the buffer layer 52 may be the same material as that of the protective film 51 or may be a different material.

The thickness (T_{buffer}) of the buffer layer 52 is preferably 0.4 μm to 1 μm. This is because the electric field efficiency VπL can be reduced.

### (Electrodes 25 and 26)

When the optical modulator of the present disclosure is used in an eyeglasses-type image display device, the widths (We) of the electrodes 25 and 26 are preferably 1.0 to 4.0 km.

This is because the electric field efficiency VπL can be reduced.

When the optical modulator of the present disclosure is used in an eyeglasses-type image display device, the thicknesses (Te) of the electrodes 25 and 26 are preferably 0.1 to 5 μm.

This is because microwaves propagate more efficiently if the electrode has a large cross-sectional area when the modulation frequency is high.

A constitution in which the ridge optical waveguide is formed using a bulk of lithium niobate adhered onto a substrate with the C-axis of lithium niobate in a direction parallel to the main surface of the substrate may be adopted.

### [Light Source Module]

A light source module according to the present disclosure includes the optical modulator according to the present disclosure and a plurality of laser light sources.

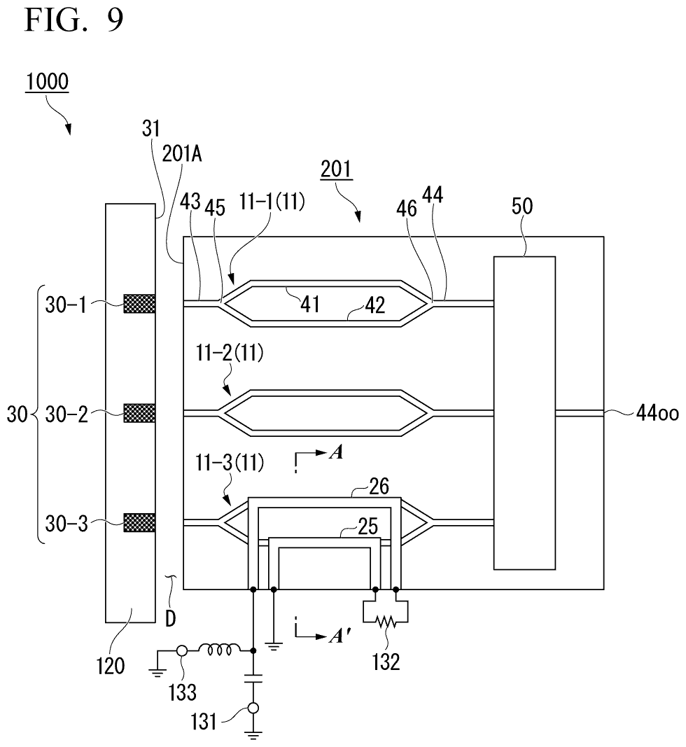

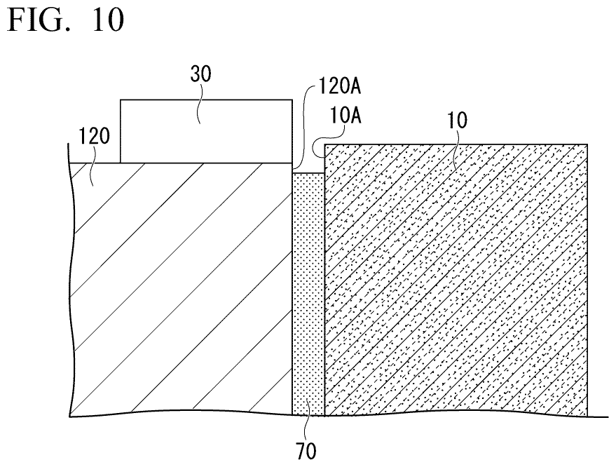

FIG. 9 is a schematic plan view of a light source module according to the present disclosure. FIG. 9 shows an example of a light source module including the optical modulator 201 shown in FIG. 8. In addition, FIG. 10 is a schematic cross-sectional view of a part of the light source module shown in FIG. 9 cut along an XZ plane, depicting only a part in the vicinity of a joint portion.

A light source module 1000 shown in FIG. 9 includes the optical modulator 201, and three laser light sources 30 (30-1, 30-2, and 30-3) emitting light to be modulated in the optical modulator 201.

Various laser elements can be used as the laser light sources 30. The laser light sources 30 can be visible light sources. In this case, the light source module 1000 is a visible light source module.

For example, commercially available laser diodes (LDs) for red light, green light, blue light, and the like can be used as the three laser light sources 30-1, 30-2, and 30-3. Light having a peak wavelength of 610 nm to 750 nm can be used as red light, light having a peak wavelength of 500 nm to 560 nm can be used as green light, and light having a peak wavelength of 435 nm to 480 nm can be used as blue light.

In the light source module 1000, the laser light sources 30-1, 30-2, and 30-3 are an LD emitting green light, an LD emitting blue light, and an LD emitting red light, respectively. The LDs 30-1, 30-2, and 30-3 are disposed with a gap therebetween in a direction substantially orthogonal to an emission direction of light emitted from each LD and are provided on an upper surface of a sub-carrier 120.

The LDs 30 can be mounted on the sub-carrier 120 as bare chips. For example, the sub-carrier 120 is made of aluminum nitride (AlN), aluminum oxide (Al₂O₃), silicon (Si), or the like.

The sub-carrier 120 can be constituted to be directly joined to the substrate 10 with a metal joint layer therebetween. Due to this constitution, further miniaturization can be achieved by not performing spatial coupling or fiber coupling.

Due to the constitution in which the sub-carrier 120 and the substrate 10 are joined with a metal joint layer therebetween, optical axis positions of laser light can be aligned (active alignment) such that the optical axis of each visible light laser matches the axis of each optical waveguide 43 by adjusting the relative position of the sub-carrier 120 and the substrate 10 at the time of manufacturing.

In the light source module 1000, a light emission surface 31 of the LDs 30 and a light incidence surface (side surface) 201A of the optical modulator 201 are disposed with a predetermined gap therebetween. The light incidence surface 201A faces the light emission surface 31, and there is a clearance D between the light emission surface 31 and the light incidence surface 201A in the x direction. Since the light source module 1000 is exposed to the air, the clearance D is filled with air. Since the clearance D is in a state of being filled with the same gas (air), it is easy to cause the light of respective colors emitted from the LDs 30 to be incident on an incidence path in a state of satisfying predetermined coupling efficiency. When the light source module 1000 is used for AR glasses and VR glasses, in consideration of the amount of light and the like required for AR glasses and VR glasses, the size of the clearance (gap) D in the x direction is larger than 0 μm and is equal to or smaller than 5 μm, for example.

### [Optical Engine and XR Glasses]

In this specification, an optical engine is a device including a plurality of light sources, an optical system including a coupling portion gathering a plurality of rays of light emitted from the plurality of light sources into one ray of light, an optical scanning mirror reflecting light emitted from the optical system at various angles so as to display an image, and a control element controlling the optical scanning mirror.

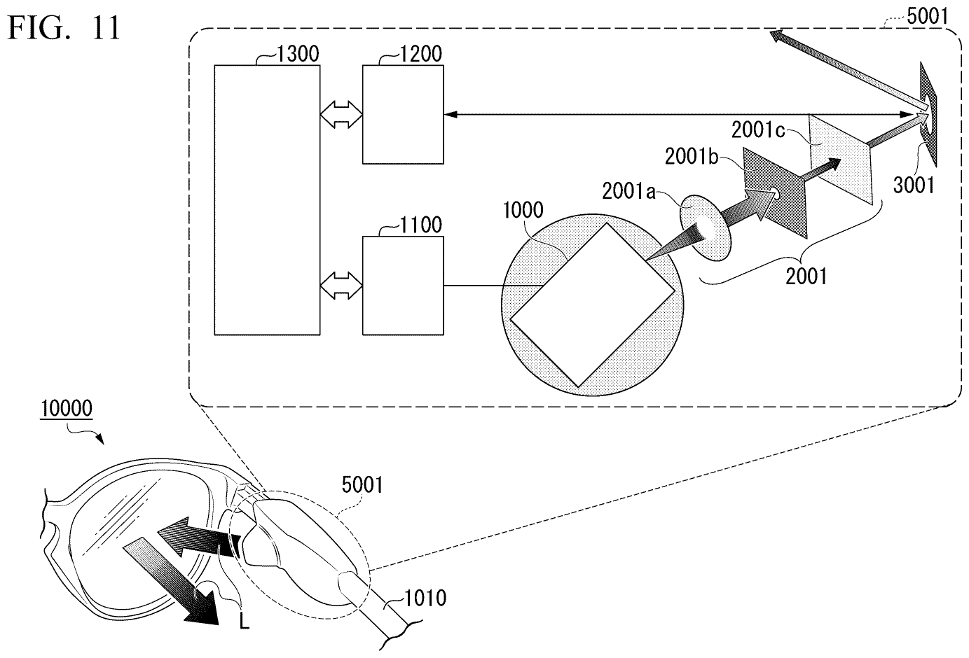

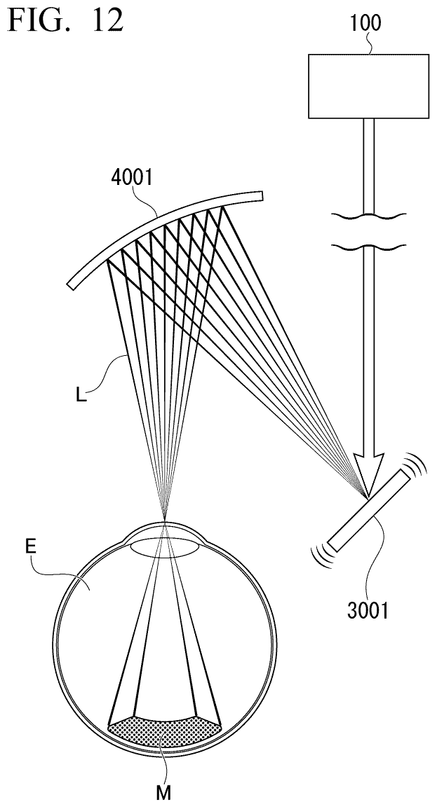

FIG. 11 is an explanatory conceptual diagram of an example of XR glasses of the present disclosure. FIG. 12 is a conceptual diagram showing a situation in which an image is directly projected onto the retina using laser light emitted from the light source module in the XR glasses shown in FIG. 11. The reference sign L indicates image display light.

XR glasses (eyeglasses) 10000 of the present disclosure are an eyeglasses-type terminal. XR is a general term for virtual reality (VR), augmented reality (AR), and mixed reality. The reference sign L shown in FIG. 12 indicates image display light.

In the XR glasses 10000 of the present disclosure shown in FIG. 11, the light source module 1000 according to the embodiment described above is mounted in an optical engine 5001 installed in a frame 1010.

As shown in FIG. 11, the optical engine 5001 has the light source module 1000, an optical scanning mirror 3001, an optical system 2001 connecting the light source module 1000 and the optical scanning mirror 3001, a laser driver 1100, an optical scanning mirror driver 1200, and a video controller 1300 controlling these drivers.

For example, a MEMS mirror can be used as the optical scanning mirror 3001. In order to project a 2D image, it is preferable to use, as the optical scanning mirror 3001, a two-axis MEMS mirror vibrating so as to reflect laser light at various angles in a horizontal direction (X direction) and a perpendicular direction (Y direction).

The optical system 2001 performs optical processing of laser light emitted from the light source module 1000. For example, a system having a collimator lens 2001a, a slit 2001b, and an ND filter 2001c can be used as the optical system 2001. The optical system 2001 shown in FIG. 11 is an example, and other constitutions may be adopted.

In the XR glasses 10000 of the present disclosure shown in FIG. 11, as shown in FIG. 12, laser light R emitted from the light source module 1000 attached to the frame 1010 is reflected by the optical scanning mirror 3001, is further reflected by a lens 4001 of the XR glasses 10000, and enters the inside of a person's eyeball E as the image display light L so that an image (video) can be directly projected onto a retina M.

Since the light source module 1000 of the present disclosure is mounted in the XR glasses 10000 of the present disclosure, the electric field efficiency is reduced.

### [Optical Communication Transmission Device]

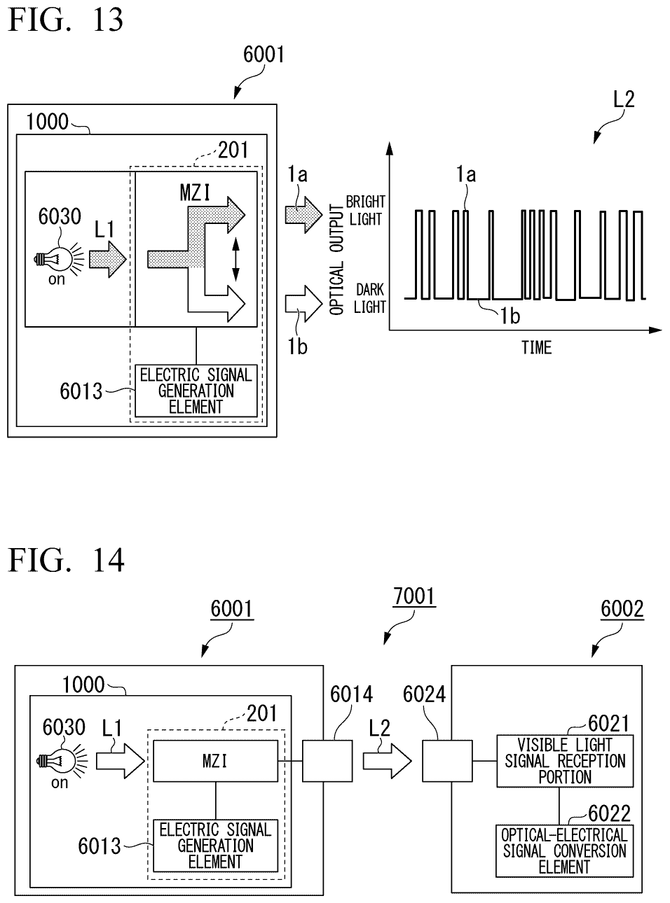

FIG. 13 is an explanatory conceptual diagram of an optical communication transmission device according to the present disclosure and an optical signal generated by the transmission device. The transmission device according to the present disclosure is a transmission device transmitting a signal to a reception device. Since a visible light signal can be used as an optical signal, a case of using a visible light signal will be described hereinafter.

An optical communication transmission device 6001 according to the present disclosure includes the light source module 1000 including an optical semiconductor element (laser) 6030 and the optical modulator 201 having a Mach-Zehnder-type optical waveguide MZI and an electric signal generation element 6013 having a function similar to that of the signal generation controller 2. Hereinafter, the optical semiconductor element (laser) may be referred to as an LD and the optical modulator may be referred to as an LN 201.

The laser 6030 emits L1. The laser 6030 is continuously in an ON state. The term “continuously” means that the laser 6030 is in the ON state during the period of time in which a visible light signal is transmitted to the reception device. The wavelength of L1 emitted by the laser 6030 is generally within a range of 380 nm to 830 nm.

The electric signal generation element 6013 receives information data to be transmitted, and this acts on the Mach-Zehnder-type optical waveguide MZI as an electric signal.

The light source module 1000 generates a visible light signal L2 by modulating the optical intensity of the LN 201 on the basis of the electric signal received from the electric signal generation element 6013.

### (Optical Communication System)

FIG. 14 is a block diagram of an optical communication system according to the present disclosure.

An optical communication system 7001 shown in FIG. 14 transmits the visible light signal L2 generated by the optical communication transmission device 6001 to an optical communication reception device 6002 via external space.

The transmission device 6001 shown in FIG. 14 is the same as the transmission device 6001 shown in FIG. 13 except that a visible light signal emission port 6014 is included. The visible light signal emission port 6014 is an emission port connected to the optical modulator 201 and radiating the visible light signal L2 generated by the optical modulator 201 to the external space.

The reception device 6002 includes a visible light signal reception portion 6021, an optical-electrical conversion element 6022, and a visible light signal incidence port 6024. The visible light signal incidence port 6024 is an incidence port for receiving the visible light signal L2 transmitted from the transmission device 6001. The visible light signal reception portion 6021 is connected to the visible light signal incidence port 6024, receives the visible light signal L2 incident on the visible light signal incidence port 6024, and emits it to the optical-electrical conversion element 6022. The optical-electrical conversion element 6022 converts the visible light signal L2 into an electric signal. The optical-electrical conversion element 6022 is not particularly limited, and any kind of element may be used as long as it is an element capable of detecting the visible light signal L2 fast and converting it into an electric signal.

The optical communication system 7001 performs visible light communication as follows.

In the transmission device 6001, as described above, the visible light signal L2 is generated by the optical modulator 201. The generated visible light signal L2 is radiated to the external space via the visible light signal emission port 6014.

The radiated visible light signal L2 is received by the visible light signal reception portion 6021 via the visible light signal incidence port 6024 of the reception device 6002. The received visible light signal L2 is converted into an electric signal by the optical-electrical conversion element 6022, and information data imparted to the visible light signal L2 is extracted.

According to the optical communication system 7001 of the present disclosure having the constitution described above, since the intensity of the visible light signal L2 emitted from the transmission device 6001 is high, it is easy to visually confirm a communication path of the visible light signal L2. Thus, erroneous data transmission can be prevented. In the case of a communication system using infrared light, it is not possible to visually confirm whether or not a visible light signal is being received by the reception device of a transmission destination. For this reason, there is a risk of transmission to a party to whom transmission is not desired to be performed originally. According to the optical communication system 7001 of the present disclosure in which the data transfer speed per second can be increased to a high speed, such as 10 Gbit/s or higher and several hundred Gbit/s to 1 Tbit/s, a huge amount of data can be transmitted per second, which is very convenient but it also increases a risk of transmitting data to a wrong party. For this reason, visible light communication, in which whether or not a visible light signal is being transmitted to a transmission destination can be visually confirmed before data is transmitted, has a significant advantage from the viewpoint of preventing erroneous data transmission. With infrared light which cannot be visually recognized, data transmission is always accompanied by anxiety.

In addition, an advantage of using visible light is that the size of the optical waveguide can be reduced because visible light has a shorter wavelength than infrared light. That is, the size of the optical modulator can also be reduced. Since the size per side of an optical waveguide for visible light can be made approximately ⅓ to ¼ smaller than that of an optical waveguide for infrared light, it can be reduced to 1/9 to 1/16 in terms of area. That is, the number of elements which can be obtained from one element creation substrate is approximately 10 times or more, and therefore the manufacturing costs of optical modulators can be reduced to 1/9 to 1/16. For example, it is possible to realize consumer applications of information terminals such as smartphones. As long as infrared light is used, the chip size cannot be reduced. That is, the cost of the modulation element becomes high, making it extremely difficult and impractical to be used for consumer applications.

As above, the following two points are advantages to using visible light for high-speed optical communication.
(1) In high-speed optical communication, a transmission destination can be visually confirmed before transmission, and a large volume of data can be transmitted and received safely.
(2) The element size of the optical modulator can be reduced. Accordingly, the manufacturing costs of optical modulators can be reduced to 1/10 or lower. Accordingly, it is possible to enjoy the advantage of ultrahigh-speed communication for consumer applications as well.

In the optical communication system of the present disclosure, light transmission means such as an optical fiber may be used for a visible light signal.

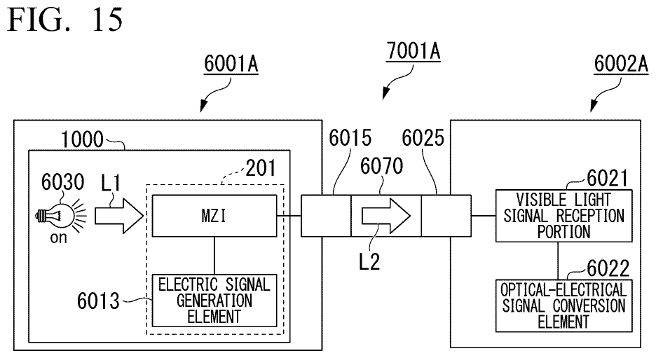

FIG. 15 is a block diagram showing a modification example of an optical communication system according to another embodiment.

An optical communication system 7001A shown in FIG. 15 differs from the optical communication system 7001 shown in FIG. 14 in that the visible light signal L2 generated by a transmission device 6001A is transmitted to a reception device 6002A via an optical fiber 6070.

In the optical communication system 7001A shown in FIG. 15, the transmission device 6001A differs from the transmission device 6001 in including an output optical fiber connection portion 6015 in place of the visible light signal emission port 6014. The output optical fiber connection portion 6015 is a connection portion connected to the optical modulator 201 and the optical fiber 6070 and outputting the visible light signal L2 generated by the optical modulator 201 to the optical fiber 6070.

The reception device 6002A includes the visible light signal reception portion 6021, the optical-electrical conversion element 6022, and an input optical fiber connection portion 6025. The input optical fiber connection portion 6025 is a connection portion connected to the optical fiber 6070 and the visible light signal reception portion 6021 and inputting the visible light signal L2 which has been transmitted through the optical fiber 6070 to the visible light signal reception portion 6021.

The optical communication system 7001A performs visible light communication as follows.

In the transmission device 6001A, as described above, the visible light signal L2 is generated by the optical modulator 201. The generated visible light signal L2 is output to the optical fiber 6070 via the output optical fiber connection portion 6015. The output visible light signal L2 propagates through the optical fiber 6070 and is received by the visible light signal reception portion 6021 via the input optical fiber connection portion 6025 of the reception device 6002A. The received visible light signal L2 is converted into an electric signal by the optical-electrical conversion element 6022, and information data imparted to the visible light signal L2 is extracted.

According to the optical communication system 7001A of the present disclosure having the constitution described above, since the visible light signal L2 generated by the transmission device 6001A is transmitted to the reception device 6002A via the optical fiber 6070, the visible light signal L2 can be transmitted to a place where light does not penetrate, such as a room partitioned by a wall, for example.

### EXPLANATION OF REFERENCES

1 Mach-Zehnder-type optical modulator
2 Signal generation controller
10 Substrate
100, 200, 201 Optical modulator
1000 Light source module
5001 Optical engine
6001 Optical communication transmission device
7001 Optical communication system
10000 XR glasses

What is claimed is:

1. An optical modulator comprising:
a Mach-Zehnder-type lithium niobate ridge optical waveguide;
an electrode for applying an electric signal to the ridge optical waveguide;
an optical switch configured to switch light output from the ridge optical waveguide;
an electric signal source generating the electric signal; and
a control circuit controlling the electric signal source and the optical switch,
wherein the control circuit controls the electric signal source such that the electric signal alternates between a positive value and a negative value on a time axis, and controls the optical switch so as to extract only light output when the electric signal of a positive value or a negative value is applied.

2. The optical modulator according to claim 1,
wherein the ridge optical waveguide is formed of a lithium niobate film formed on a substrate, and
a C-axis of the lithium niobate is oriented in a direction perpendicular to a main surface of the substrate.

3. The optical modulator of claim 1,
wherein the ridge optical waveguide is formed of a bulk of lithium niobate adhered onto a substrate, and
a C-axis of the lithium niobate lies in a direction parallel to a main surface of the substrate.

4. The optical modulator of claim 1,
wherein the electric signal is a square wave voltage signal.

5. The optical modulator according to claim 4,
wherein a duty ratio of the electric signal is set such that an average voltage becomes 0 V.

6. The optical modulator according to claim 1,
wherein a frequency of the electric signal is 1 MHz or higher.

7. The optical modulator of claim 1,
wherein the electric signal source includes a modulation signal source and a bias signal source.

8. A visible light source module comprising:
the optical modulator according to claim 1,
wherein the optical modulator has an optical coupling portion, and
the visible light source module comprises a plurality of visible laser light sources emitting visible light coupled by the optical coupling portion.

9. An optical engine comprising:
the visible light source module according to claim 8; and
an optical scanning mirror reflecting light emitted from the visible light source module at various angles so as to display an image.

10. XR glasses comprising:
the optical engine according to claim 9 mounted therein.

11. An optical communication transmission device comprising:
the optical modulator according to claim 1.

12. An optical communication system comprising:
the optical communication transmission device according to claim 11; and
an optical communication reception device having an optical signal reception element for receiving light.

13. A method for controlling an optical modulator having a lithium niobate ridge optical waveguide and an optical switch provided on an output side of the ridge optical waveguide, the method comprising:
applying an electric signal alternating between a positive value and a negative value on a time axis to the ridge optical waveguide; and
controlling the optical switch so as to extract an output signal from the ridge optical waveguide when a voltage having a positive value or a negative value is applied.

14. A visible light source module comprising:
the optical modulator according to claim 2,
wherein the optical modulator has an optical coupling portion, and
the visible light source module comprises a plurality of visible laser light sources emitting visible light coupled by the optical coupling portion.

15. A visible light source module comprising:
the optical modulator according to claim 3,
wherein the optical modulator has an optical coupling portion, and
the visible light source module comprises a plurality of visible laser light sources emitting visible light coupled by the optical coupling portion.

16. A visible light source module comprising:
the optical modulator according to claim 4,
wherein the optical modulator has an optical coupling portion, and
the visible light source module comprises a plurality of visible laser light sources emitting visible light coupled by the optical coupling portion.

17. A visible light source module comprising:
the optical modulator according to claim 5,
wherein the optical modulator has an optical coupling portion, and
the visible light source module comprises a plurality of visible laser light sources emitting visible light coupled by the optical coupling portion.

18. A visible light source module comprising:
the optical modulator according to claim 6,
wherein the optical modulator has an optical coupling portion, and
the visible light source module comprises a plurality of visible laser light sources emitting visible light coupled by the optical coupling portion.

19. A visible light source module comprising:
the optical modulator according to claim 7,
wherein the optical modulator has an optical coupling portion, and
the visible light source module comprises a plurality of visible laser light sources emitting visible light coupled by the optical coupling portion.

20. An optical communication transmission device comprising:
the optical modulator according to claim 2.
